(19) United States
(12) Patent Application Publication
(10) Pub. No.: US 2005/0223113 A1
(43) Pub. Date: Oct. 6, 2005

(54) Runtime-dependent switching off of the echo compensation in packet networks

(76) Inventor: Klaus Hoffmann, Munchen (DE)

Correspondence Address: Siemens Corporation;Intellectual Property Department, 170 Wood Avenue South, Iselin, NJ, 08830, US

(21) Appl. No.: 10/519,626

(22) PCT Filed: Jun. 11, 2003
(86) PCT No.: PCT/DE03/01948

§ 371 Date: Dec. 28, 2004

(30) Foreign Application Priority Data
Jul. 2, 2002 (DE) 102 29 680.4

(51) Int. Cl. G06F 15/173

(52) U.S. Cl. 709/245; 709/238

(57) ABSTRACT

The invention relates to the switching off of echo compensations as a function of the useful data transmission time for a packet network. On changes to a packet network connection, for example with relation to a diversion or forwarding of speech connections, the useful data transmission time for the changed packet network connection is determined. Where the determined useful data transmission time falls below the threshold value, the switching off of the echo compensation is carried out. The invention permits the dynamic switching off of echo compensators which are no longer required, due to a reduced useful data transmission time.

### CROSS REFERENCE TO RELATED APPLICATIONS

This application is the US National Stage of International Application No. PCT/DE03/01948, filed Jun. 11, 2003 and claims the benefit thereof. The International Application claims the benefits of German application No. 10229680.4 filed Jul. 2, 2002, both of the applications are incorporated by reference herein in their entirety.

### FIELD OF INVENTION

The invention relates to a method and a gateway for switching off an echo compensation for a useful data connection in a packet network while shortening the packet delay time.

### BACKGROUND OF INVENTION

In switching technology, methods for the echo compensation play an important role for high-quality speech transmission.

A distinction is typically made in telephony between the following three factors which reduce the quality during speech transmission: delay time, signal distortions and echo. The effect of echo, i.e. the reflection of speech signals depends on the signal delay time. In general, an echo with a limited time interval, e.g. 25 to 30 ms, hardly impairs the quality of a telephone call. A specific form of echo with a delay of approximately 28 ms, namely local echo, even has the desired effect that the speaker, when speaking, hears his own voice from the ear piece. However, in the case of a longer signal delay time, the result is a greater adverse effect on the quality of the telephone call because of echo effects, which is why echo is suppressed with echo compensation methods.

Echo compensation is a method established for time division multiplexing networks in “classic” telephony. Transmitting speech over packet networks such as IP (Internet Protocol) networks, results in a changed situation compared to time division multiplex networks:

Packets are routed in the packet network. They are routed on the basis of destination addresses. When routing of packets is changed (e.g. rerouting as part of call diversion), the destination address is usually replaced in the packet headers by the address of the new destination. Packets are routed to the new destination independent of the original destination. As a result, the transmission time to the new destination can be shorter or longer than that for the original destination. Transmission to the new destination can require a switching on or a switching off of the echo compensation.

Modern packet networks allow “virtual trunking”, i.e. the separate routing and transmission of signaling messages and useful data. Measures for echo compensations must take this more complex architecture into account. The methods specific to the packet network for setting up and controlling the connection, e.g. by specifying the address in the packet header, lead to new methodical requirements compared to the time division multiplex networks.

### SUMMARY OF INVENTION

The object of the invention is the delay time-dependent switching off of the echo compensation in packet networks.

The invention relates to the situation in which an echo compensation provided for a connection must be switched off in a packet network because, as part of a change in the packet delay time or the transmission time of useful data, echo compensation is no longer required. According to the invention, a threshold value is used for the useful data transmission time or the delay time of the useful data that represents a lower limit for switching off the echo compensation. When the useful data connection or the packet delay time are changed, e.g. within the framework of call forwarding, the new useful data transmission time is determined for a changed packet transmission link. If echo compensation is switched on, a subsequent test is carried out to determine whether or not the specific useful data transmission time of the changed useful data connection falls below the threshold value for switching off the echo compensation and, in falling below the threshold value, switches off the echo compensation.

Forwarding or diverting a connection in the packet network can result in a shorter transmission time for useful data because useful data is usually not routed via the original destination to the new destination within the context of the diversion. Instead, address information about the new destination is usually used for the routing which replaces the address information of the old destination. The packet delay time or the route regarding routing to the new address can be shorter than in the case of the original connection. The specification in the invention of a limit, e.g. 32 ms for switching off the echo compensation, supplies a criterion for providing the echo compensation. If the limit or the threshold value is undershot, the echo compensation should be switched off. Such a switching off is recommended, for example, in the standard G. 131 ITU-T “Control of Talker Echo” in section 5.2.1.1, Rule 7: “Connections that do not require Echo Control Devices should not be fitted with them, because they increase the fault rate and are an additional maintenance burden”. A criterion for the decision of the recommended switching off of the echo compensation in the case of short transmission times is given according to the invention by determining the useful data transmission time for the changed circumstances or the connection and comparing the new useful data transmission time to the threshold value. Where the new useful data transmission time falls below the threshold value, the echo compensation is switched off. An existing echo compensation can thus be suppressed dynamically and as required in such a way.

In many modern packet-based networks, signaling messages and useful data are transmitted separately. The connection control is then handled by control devices such as media gateway controllers and in relation to IN (Intelligent Network) concepts these control devices are referred to as Service Nodes (abbreviated SN). The useful data is transmitted by means of gateways, e.g. media gateways, access gateways or residential gateways which transports the useful data packets or useful data flows according to address information. In this situation, a distinction is made between three groups of protocols used. On the signaling level, control or signaling information is exchanged by means of protocols such as the BICC protocol (BICC: Bearer Independent Call Control), an adapted ISUP protocol (ISUP: ISDN User Part) or the SIP protocol (SIP: Session Initiation Protocol). On the level of useful data transmission, application-specific protocols such as the RTP protocol defined in the RFC (Request For Comments) 1889 “Transport protocol for real time application” which was especially designed for speech and video transmission are used. Finally, protocols for communication between these two levels or the device elements on the signaling level and the device elements on the useful data level are required. For this, the MGCP (Media Gateway Control Protocol) is, for example, used which is defined in RFC2705 or the protocol defined in ITU-T H.248. At lower levels overlaps with regard to the protocol stacks used can occur for the three groups of protocols, for example, the IP protocol on the transmission level and the UDP or the TCP protocol on the transport level. As a result, in an embodiment of the invention for a separate transmission of the signaling and the useful data in packet networks, a control device and a gateway are used for the method according to the invention. In this embodiment, the control device and the gateway can also be implemented in a physical device by means of integrated logical functions. In order to send the threshold value from the control device to the gateway, the MGCP protocol can, for example, be used. To this end, the MGCP protocol is expanded in an embodiment of the invention: A new event is provided in the RCP package of the MGC protocol. This event can be defined as “Propagation Delay Decreased” and includes the numerical value of the duration as a parameter for the threshold value. This expansion then takes the following form in accordance with the notation of RFC2705:

| | | | | |
|---|---|---|---|---|
| Symbol | Definition | R | S | Duration |

| | | |
|---|---|---|
| PDD(###) | Propagation delay | X |
| | decreased | |

In this case, “###” symbolizes a numerical value for the delay or the useful data transmission time, for example, in ms. The modified RTP package can, as part of a notification request or an encapsulated notification request, be sent from the control device to the gateway, for example, in the course of a create connection message. On changing or diverting the useful data connection, for example, in the course of a bearer redirection procedure which is described in the ITU-T Q.1902.6 standard specification, the gateway determines the useful data transmission time of the changed useful data connection. The useful data transmission time can be determined at regular intervals, e.g. in the form of checking a network congestion which manifests itself in a corresponding increase in the transmission times. Alternatively, useful data transmission time measurements are triggered by changes in the useful data connection. For example, as part of the bearer redirection procedure for diverting the useful data stream transferred signaling messages will trigger the measurement of the useful data transmission time.

The useful data transmission time can, for example, be established by determining the round trip for packets described in the RFC (Request For Comments) 1889 section 6.3.1. Half of the round trip for packets determined with this procedure represents an estimation for the useful data transmission time of the connection searched for in which case this information is combined with the jitter buffer which describes the variance in the arrival of packets. After the useful data transmission time has been determined, it is compared with the threshold value and reported to the control device should the determined useful data transmission time fall below the threshold value. Based on this message, the control device switches off the echo compensation.

For the described sequences in the gateway, a procedure for determining useful data transmission times can, for example, be implemented in this gateway by means of a method for determining the round trip described in the RFC1889. In addition, program structures are necessary which permit a comparison of useful data transmission times determined with the threshold value given by the control device. The echo compensation can also be switched off via the gateway if the echo compensation is in the gateway's area of responsibility. When the MGC protocol is used, this switching off of the gateway can also be carried out by using the MDCX instruction (MDCX: Modify Connection) which is transmitted from the control device to the gateway.

Another situation results if the echo compensation is not in the area of responsibility of the control device or of a gateway controlled by the control device. In this case, the switching off request can be signaled to another control device by using the enhanced echo control procedure which is described in section 2.7.2 of the ITU-T standard Q.764. This functions by means of sending an NRM (Network Resource Management) message by means of the protocol used on the control level, said protocol being, for example, the ISUP or the BICC. According to table 46 of the ITU-T standard Q.763 “signaling system No. 7—ISDN user part formats and codes”, the NRM message can contain an “echo control information” parameter, i.e. be used for transporting control information for the echo compensation.

The addressee of the NRM message is a control device that has access directly or indirectly (i.e. via a gateway) to the echo compensation to be switched off. On receipt of the NRM message, this control device activates the desired switching off process.

### BRIEF DESCRIPTION OF THE DRAWINGS

Examples of embodiments of the invention are shown and explained in the following by way of drawings. They are as follows:

FIG. 1A system for a connection of PSTN users routed via a packet network separately transmitting the signaling messages and the useful data

FIG. 2 Diversion of the A-side useful data flow to an IVR server (IVR: Interactive Voice Response)

### DETAILED DESCRIPTION OF INVENTION

In this case, the same reference symbols designate the same elements.

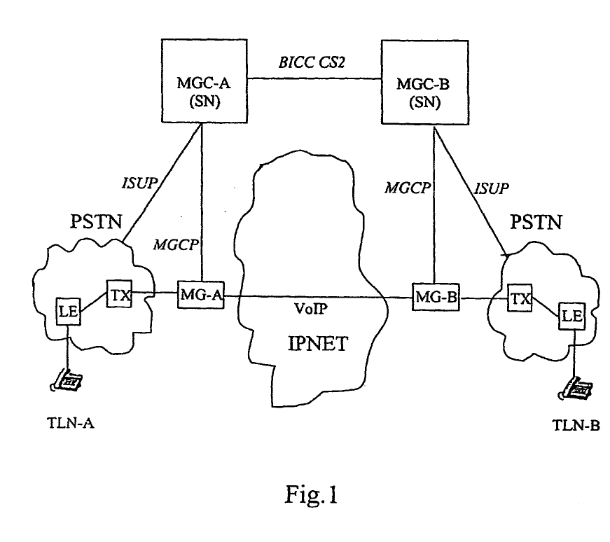

FIG. 1 shows a typical speech connection of two PSTN users TLN-A and TLN-B routed via a packet network IPNET. In this case the useful data and signaling messages are transmitted separately in accordance with the SS7 system (SS7: Signaling System No. 7). The end users TLN-A and TLN-B are in each case connected to the PSTN (Public Switched Telephone Network) network via local trunk exchanges LE that are close to the user. Via one or more transit exchanges TX of the PSTN network, useful data can be transmitted to network access devices or to gateways MG-A or MG-B (MG: Media Gateway). Useful data transmitted from the A-user TLN-A to the B-user TLN-B is adapted in the network access devices MG-A or MG-B for speech transmission via the packet network IPNET. For a packet network operating on the basis of the IP (Internet Protocol) protocol, the transmission of speech is referred to as voice-over-IP, abbreviated as VoIP. As a result, signaling for setting up the connection between the two users TLN-A and TLN-B is handled separately by the useful data transmission. Signaling messages transmitted from the PSTN network within the context of connection control are sent to the control device or the media gateway controller MGC-A by using the ISUP (ISDN User Part). By sending control messages to the network access device MG-A using the MGCP protocol, the control device MGC-A activates the control of the transmission of useful data via the packet network IPNET. In the case of a system which is embodied according to an IN (Intelligent Network) architecture, the control devices MGC-A or MGC-B are referred to as service nodes (abbreviated SN). For the connection setup or connection control between the end users TLN-A and TLN-B, signaling messages are exchanged between the control device MGC-A and the control device MGC-B which control the B-side network access device MG-B. This exchange of messages is carried out, for example, by using the BICC CS2 (Barer Independent Call Control—Capability Set No. 2) protocol. Therefore, signaling messages can then be forwarded from the B-side control device MGC-B to the B-side PSTN network by using the ISUP protocol.

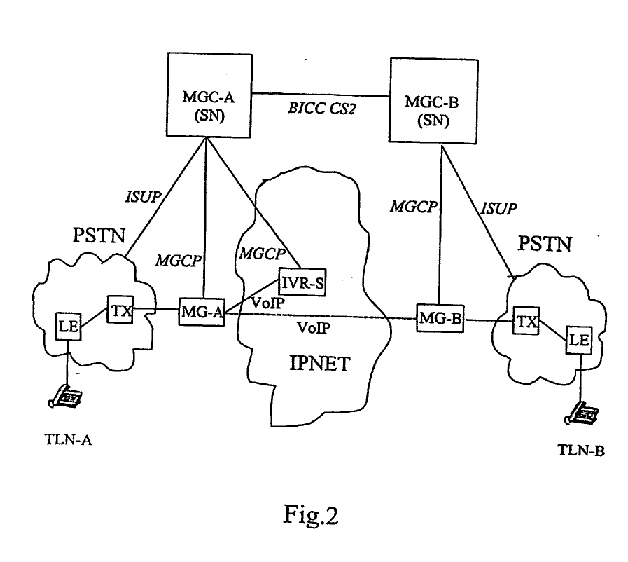

FIG. 2 shows the system from FIG. 1, with an IVR (Interactive Voice Response) server IVR-S being shown as the additional device element. This IVR server is controlled by the control device MGC-A through the MGC protocol. IVR servers serve to provide speech-associated service features such as creating announcement texts or providing automated dialog sequences. For example, as part of a connection setup request of the user TLN-A with the B-user TLN-B, the non-accessibility of the B-user TLN-B is established and an announcement function provided by the IVR server IVR-S is activated which informs the A-user TLN-A about the non-accessibility of the B-user. Therefore, in the case of incorrectly entered call number information, the IVR server IVR-S, for example, outputs for the A-user TLN-A, the text “no connection under this number”. In order to access the IVR resources that are provided by the IVR server IVR-S, the useful data connection to the IVR server IVR-S must be diverted. For this, the bearer redirection procedure which is described in the ITU-Q.1902.6 standard specification is, for example, available. As part of this procedure, the useful data connection between the network access devices MG-A and MG-B is replaced by the useful data connection between the network access device MG-A and the IVR server IVR-S. Changing this path of the useful data brings about a change in the transmission link resulting in a new situation regarding the necessity for an echo compensation. For example, an echo compensation was needed for the useful data connection between the MG-A and the MG-B (shown with a dotted line in FIG. 2) which is not relevant to the useful data connection between the access device MG-A and the IVR server IVR-S. According to the invention, this is expressed by the fact that the useful data transmission time falls below a threshold value. Such a useful data diversion that requires a splitting off of the echo compensation is detected in the network access device MG-A and reported to the control device MGC-A. For detecting a change in the useful data connection, the network access device MG-A is programmed or configured by the control device MGC-A as part of the connection setup or is programmed or configured during the connection. On using the MGCP protocol according to the RFC2705 standard, procedures for the instruction to the network access device MGC-A described therein can be used. For example, the instruction “notification request” is used. This instruction can be used to activate gateways for sending information (notification) about the occurrence of specific events to the authorized gateway controller. The notification request contains a list of instructions (in the “Requested Events” standard) to be implemented by a media gateway. Within the framework of the protocol, so-called event packages are defined which specify lists of events and actions that can be detected or carried out. Such a package is the so-called RTP (Real Time Protocol) package which is used for the control or to control RTP flows. Therefore, in this package, a new requested event is introduced with the name ‘propagation delay decreased’ which includes as parameter the threshold value for switching off the echo suppressors. As a result, the RTP package can be sent as part of the notification request to the network access device MG-A. Therefore, on receiving the notification request, the network access device MG-A detects a change in the network data transmission and sends a signal to the control device MGC-A that the data transmission is falling below the threshold value. The notification request can also be sent from the control device MGC-A to the network access device MG-A as an optional element of the create connection instruction, typically in the form of an encapsulated notification request as part of the connection setup. Alternatively, the notification request—typically if a connection has already been set up—is sent as an independent command or independent instruction to the network access device MGC-A. If a create connection instruction is used, the connection setup introduced by this instruction is at the same time carried out with the measures required by the notification request for detecting a change in the useful data transmission.

Changes in the useful data transmission as, for example, shown in FIG. 1 measure the delay time of the new useful data connection arising (in FIG. 2 between the network access device MG-A and the IVR server IVR-S instead of the connection drawn in dotted lines between the network access devices MG-A and MG-B). The transmission time is, for example, measured by using the round trip delay measurement described in the RFC1889, section 6.3.1 (referred to as ‘round trip delay’ in the standard). In this case, packets are sent to the new destination or the new end point and then back again. The duration for the round trip of the packet can be determined from the time stamp or the time information entered for the new destination. In order to reduce the influence of scattering in the transmission time of packets, the jitter buffer which describes the variance in the arrival of packets is usually also used. The value thus received for the round trip delay is divided by two and compared with the threshold value for switching off the echo compensation. If the delay time of the packets complies with the criterion for switching off the echo compensation, the network access device MG-A informs the control device MGC-A. A switching off of echo compensations in the case of the network access device MG-A can be used by the MGCP instruction Modify connection (MDCX) which takes the local connection options as the parameter. The local connection option contains a field “Usage of Echo Cancellation” which by using the values “on”, “and” or “off” makes possible the switching off or switching on of the echo compensation.

According to the invention it is also possible to switch off echo compensators which do not lie within the range of the media gateway which is responsible for detecting the useful data transmission time. In a variation on the above-mentioned embodiment, the useful data transmission time is measured by the B-side media gateway MG-B. For example, by means of the B-side media gateway it is possible to determine that on the basis of network fluctuations the packets sent by the A-side media gateway MG-A arrive more quickly than before and that the echo compensator must be switched off in the case of the A-side media gateway. Contrary to the case described in FIG. 2, if the useful data delay time is detected in the B-side media gateway MG-B, the echo compensation can no longer be switched off directly by means of control commands transmitted by the control device MGC-A. Instead, the control device MGC-B signals to the A-side control device MGC-A that the echo compensation must be switched off. The echo compensation can then again be undertaken by the control device MGC-A to the media gateway MG-A by means of MGCP commands or instructions. In order to signal the exceeding of the threshold value or the necessity for switching off the echo compensation by the network access device or the control device MGC-B to the control device MGC-A, procedures can be used that are given in the standard code Q.764 “Signaling System No. 7—ISDN User Part Signaling Procedures” in section 2.7.2 “Enhanced Echo Control Signaling Procedures”. By means of an NRM (Network Resource Management) message that is generated, for example, on receiving an ECRF (Echo Control Request Forward) event, the control device MGC-A triggers the switching off of the echo compensation, i.e. the control device MGC-A is activated to send an MGCP instruction to the media gateway MG-A for switching off the echo compensation.

1-9. (canceled)

10. A method for switching off an echo compensation for a data connection in a packet network when a packet delay time is reduced, comprising:
establishing a threshold value of a data transmission time that represents a lower limit for switching off the echo compensation;
changing the data connection triggers changing the data transmission time of the changed data connection;
determining if the data transmission time of the changed data connection dropped below the threshold value when the echo compensation is switched on;
switching off the echo compensation via a control device and a gateway, and sending the threshold value from the control device to the gateway when the determined data transmission time falls below the threshold value, determining the data transmission time of the changed data connection when the gateway changes the data connection;
checking by the gateway if the data transmission time of the changed data connection falls below the threshold value when the echo compensation is switched on;
informing the control device from the gateway that the data transmission time fell below the threshold value; and
switching off the echo compensation on receiving information that the data transmission fell below the threshold value.

11. The method according to claim 10, wherein from the control device to the gateway, as part of a transfer of the threshold value via a notification request instruction of a media gateway control protocol, the gateway is made to inform the control device when there is a change in the data connection which causes it to fall below the threshold value.

12. The method according to claim 10, wherein the threshold value is sent via an event in a real time protocol package of the media gateway control protocol.

13. The method according to claim 10, wherein the data transmission time is determined by using a round trip of a message.

14. The method according to claim 10, wherein when the data transmission falls below the threshold value the echo compensation is switched off by the control device by sending a MDCX media gateway control protocol message to the gateway.

15. The method according to claim 10, further comprising:
sending a network resource management message for switching off the echo compensation to a first control entity when the echo compensation is switched off in a service area of a second control entity;
receiving the network resource management message by the second control entity; and
switching off the echo compensation in the second control entity.

16. The method according to claim 10, further comprising:
sending a network resource management message for switching off the echo compensation to a control entity when the echo compensation is switched off in the service area of the control entity; and
switching off an echo compensation by the control entity.

17. The method according claim 10, wherein the packet network is an internet protocol network.

18. The method according claim 10, wherein the packet network is an asynchronous transfer mode network.

19. The method according claim 10, wherein the data transmission time is determined at predefined intervals.

20. A communication system in a packet network for switching off an echo compensation for a connection in the packet network, comprising:
a gateway operatively connected to the packet network, the gateway adapted to monitor a transmission time of a packet for the connection when the echo compensation is on; and
a control device operatively connected to the gateway that is informed by the gateway when the transmission time has fallen below a threshold value, the control device informing the gateway when the echo compensation is to be switched off.

21. The system according to claim 20, wherein the transmission time is determined at predefined intervals.

22. The system according to claim 20, wherein determining the transmission time is triggered by a connection change.

23. The system according to claim 20, wherein the gateway switches off the echo compensation.

24. The system according to claim 20, wherein the transmission time is determined by using a round trip of a message.

25. The system according claim 20, wherein the packet network is an internet protocol network.

26. The system according claim 20, wherein the packet network is an asynchronous transfer mode network.

27. A communication system in a packet network for switching off an echo compensation for a connection in the packet network, comprising:
a gateway operatively connected to the packet network, the gateway adapted to monitor a transmission time of a packet for the connection when the echo compensation is on and turning off the echo compensation when the transmission time falls below a threshold value; and
a control device operatively connected to the gateway.

28. The system according to claim 27, wherein the transmission time is determined at predefined intervals.

29. The system according to claim 27, wherein determining the transmission time is triggered by a connection change.
